(19) United States
(12) Patent Application Publication
(10) Pub. No.: US 2016/0328200 A1
(43) Pub. Date: Nov. 10, 2016

(54) TESTING SCREENS OF A MULTI-SCREEN DEVICE

(71) Applicant: HCL Technologies Limited, Noida (IN)

(72) Inventors: Rajesh Babu SURAPARAJU, Kandanchavadi Chennai (IN); Arun Prasad SUBBARAYAN, Kandanchavadi Chennai (IN)

(21) Appl. No.: 14/982,679

(22) Filed: Dec. 29, 2015

(30) Foreign Application Priority Data
May 6, 2015 (IN) 1248/DEL/2015

(51) Int. Cl. G06F 3/14; G06F 21/84; H04L 29/06; G09G 5/12; G06F 3/0484

(52) U.S. Cl. CPC G06F 3/1423; G06F 3/1454; G09G 5/12; G06F 3/0484; H04L 63/08; G06F 21/84; G09G 2370/02

(57) ABSTRACT

Disclosed is a method for testing screens of a multi-screen device. The multi-screen device may establish connections between a plurality of users and a plurality of screens, based on access requests. The multi-screen device may receive commands to be executed on corresponding screens. The multi-screen device may capture responses of the execution by using a frame grab technique. The multi-screen device may determine a performance of each screen of the plurality of screens based on the captured responses. The multi-screen device may thus test the plurality of screens based on the performance.

### CROSS-REFERENCE TO RELATED APPLICATIONS AND PRIORITY

The present application claims benefit from Indian patent application No. 1248/DEL/2015, filed on May 6, 2015, the entirety of which is hereby incorporated by reference.

### TECHNICAL FIELD

The present subject matter described herein generally relates to remote testing of screens.

### BACKGROUND

Device screens are tested before embedding them in the device using Application Programming Interfaces (API's) or remote function calls. Conventional techniques do not allow parallel testing of multiple screens of a device. Severity of such a testing increases when the screens are distributed across different geographical areas.

### SUMMARY

This summary is provided to introduce aspects related to a multi-screen device and methods for testing screens of the multi-screen device and the aspects are further described below in the detailed description.

In one implementation, disclosed is a method for testing screens of a multi-screen device. The method may include receiving access requests from a plurality of users to access a screen of a plurality of screens of the multi-screen device. The method may include establishing connections between the plurality of users and the plurality of screens based on the access requests such that each user is connected to a single screen of the plurality of screens. The method may further include receiving commands from the plurality of users. The commands may be executed on corresponding screens. The method may further include capturing responses of the execution using a frame grab technique. The method may also include determining a performance of each screen of the plurality of screens based on the responses, thereby testing the plurality of screens.

In one implementation, a multi-screen device is disclosed. The multi-screen device includes a processor and a memory coupled to the processor for executing programmed instructions stored in the memory. The processor may receive access requests from a plurality of users to access a screen of a plurality of screens of the multi-screen device. The processor may further establish connections between the plurality of users and the plurality of screens based on the access requests such that each user is connected to a single screen of the plurality of screens. The processor may further receive commands from the plurality of users. The commands may be executed on corresponding screens. The processor may further capture responses of the execution using a frame grab technique. The processor may also determine a performance of each screen of the plurality of screens based on the responses, thereby testing the plurality of screens.

In one implementation, a non-transitory computer readable medium embodying a program executable in a computing device for testing screens of a multi-screen device is disclosed. The program may include a program code for receiving access requests from a plurality of users to access a screen of a plurality of screens of the multi-screen device. The program may further include a program code for establishing connections between the plurality of users and the plurality of screens based on the access requests such that each user is connected to a single screen of the plurality of screens. The program may further include a program code for receiving commands from the plurality of users. The commands may be executed on corresponding screens. The program may further include a program code for capturing responses of the execution using a frame grab technique. The program may further include a program code for determining a performance of each screen of the plurality of screens based on the responses, thereby testing the plurality of screens.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a multi-screen device for testing screens of the multi-screen device, in accordance with an embodiment of the present subject matter.

FIG. 2 illustrates transfer of user commands, from a plurality of users to a plurality of screens of the multi-screen device, in accordance with an embodiment of the present subject matter.

FIG. 3 illustrates transfer of responses of the user commands, by the plurality of screens of the multi-screen device to the plurality of users, in accordance with an embodiment of the present subject matter.

FIG. 4 shows flowchart illustrating a method for testing screens of the multi-screen device, in accordance with an embodiment of the present subject matter.

### DETAILED DESCRIPTION

A multi-screen device and a method for testing screens of the multi-screen device are described in the present subject matter. The multi-screen device may receive access requests from a plurality of users to access a screen of a plurality of screens of the multi-screen device. The multi-screen device may establish connections between the plurality of users and the plurality of screens based on the access requests. Each user may get connected to a single screen of the plurality of screens. The multi-screen device may receive commands from the plurality of users. The commands may get executed on corresponding screens of the multi-screen device.

Subsequently, the multi-screen device may capture responses of execution of the commands on the corresponding screens using a frame grab technique. The multi-screen device may determine a performance of each screen of the plurality of screens based on the responses. Thus, the plurality of screens may be tested in an above described manner.

While aspects of described multi-screen device and method for testing screens of the multi-screen device may be implemented in any number of different computing systems, environments, and/or configurations, the embodiments are described in the context of the following exemplary multi-screen device.

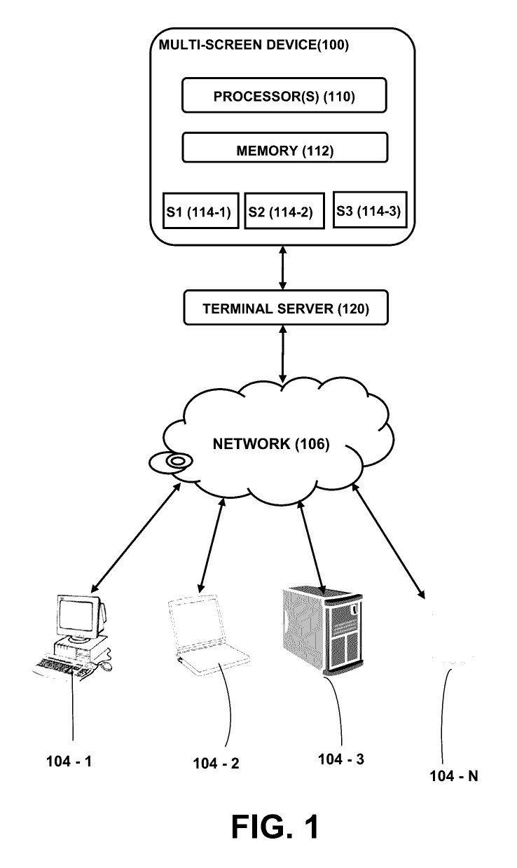

Referring now to FIG. 1, the multi-screen device 100 for testing screens of the multi-screen device is shown, in accordance with an embodiment of the present subject matter. Although the present subject matter is explained considering that the multi-screen device 100 is a computer, it may be understood that the multi-screen device 100 may also be a variety of computing systems including but not limited to, a smart phone, a tablet, a notepad, a personal digital assistant, a handheld device, a laptop computer, a notebook, a workstation, and a mainframe computer.

In one embodiment, the multi-screen device 100 may be implemented in a cloud-based environment. It will be understood that the multi-screen device 100 may be accessed by multiple users through one or more user devices 104-1, 104-2, 104-3, 104-N, collectively referred to as user device 104 hereinafter, or applications residing on the user device 104. Examples of the user device 104 may include, but are not limited to, a portable computer, a personal digital assistant, and a handheld device. The user device 104 is communicatively coupled to the multi-screen device 100 through a network 106.

In one implementation, the network 106 may be a wireless network, a wired network, or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In one embodiment, as illustrated in FIG. 1, the multi-screen device 100 may include at least one processor 110, a memory 112, and screen S1 114-1, screen S2 114-2, and screen S3 114-3. Further, the at least one processor 110 may be implemented as one or more microprocessors, microcomputers, microcontrollers, digital signal processors, central processing units, state machines, logic circuitries, and/or any devices that manipulate signals based on operational instructions. Among other capabilities, the at least one processor 110 is configured to fetch and execute computer-readable instructions stored in the memory 112.

The memory 112 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, a plurality of users operating user devices 104-1 to 104-N may generate access requests for accessing a screen of a plurality of screens of a multi-screen device 100. In one case, the access requests may be routed to the multi-screen device 100 through a network 106.

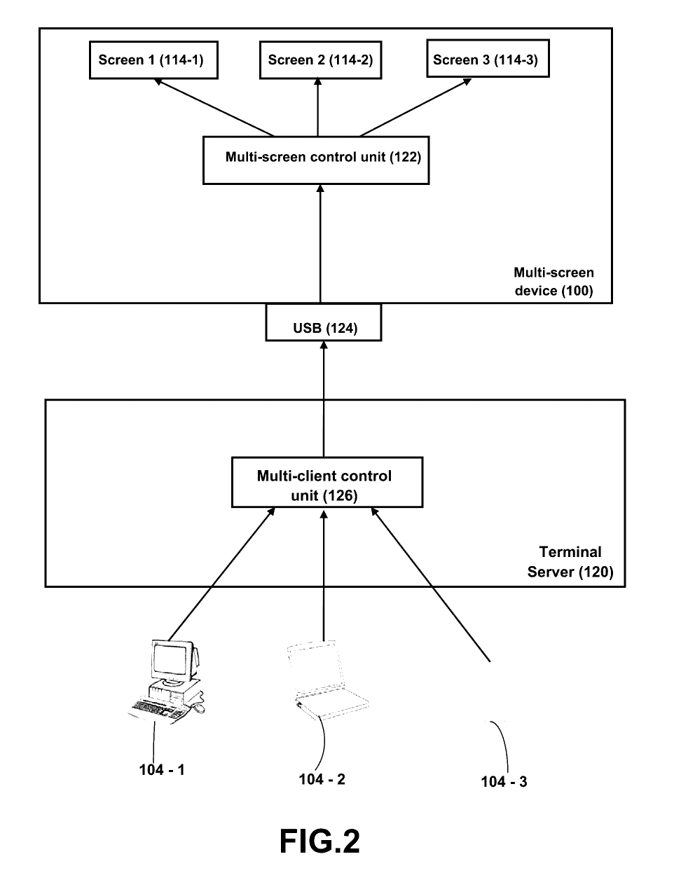

In one embodiment, the user devices may need to connect with a terminal server 120 by using a client application. Subsequently, the terminal server 120 may manage a connection between the user devices and the plurality of screens. FIG. 2 illustrates transfer of commands, from a plurality of users and the plurality of screens of the multi-screen device 100, in accordance with an embodiment of the present subject matter. The user devices may communicate with a multi-client control unit 126 of the terminal server 120.

In one embodiment, a plurality of multi-screen device may be present. The multi-client control unit 126 may provide status/availability of each screen of the plurality of multi-screen devices. In one case, the availability of the plurality of screens of the multi-screen device may be provided using a color scheme. For an example, green color may be used to indicate screens and the multi-screen devices available for testing and orange color may indicate screens and the multi-screen devices engaged by user for testing. Each user operating corresponding user devices may select available screens of the plurality of multi-screen devices for testing the screens.

Post selection of the screens by the users, the multi-client control unit 126 may multiplex data corresponding to the user devices and may generate a multiplexed data stream. The data corresponding to the user devices may refer to user commands like a right click or a left click on the screen, hovering a pointer/cursor over the screen, and hitting a key on a keyboard. In one case, the multiplexed data stream may be transmitted to a Universal Serial Bus (USB) port 124 of the multi-screen device 100. The USB port 124 may be working on a USB 2.0 or a USB 3.0 version.

Subsequent to receiving the multiplexed data stream, the multi-screen device 100 may provide the multiplexed data stream to a multi-screen control unit 122. The multi-screen control 122 unit may demultiplex the data and may provide the data to corresponding screens of the plurality of screens. In one case, the multi-screen control unit 122 may provide the data to the corresponding screens based on unique identifiers of the screens. In one case, the multi-screen control unit 122 may use a Virtual Network Computing (VNC) technique. The VNC technique may use a Remote Frame Buffer protocol (RFB) to transmit the data to each screen.

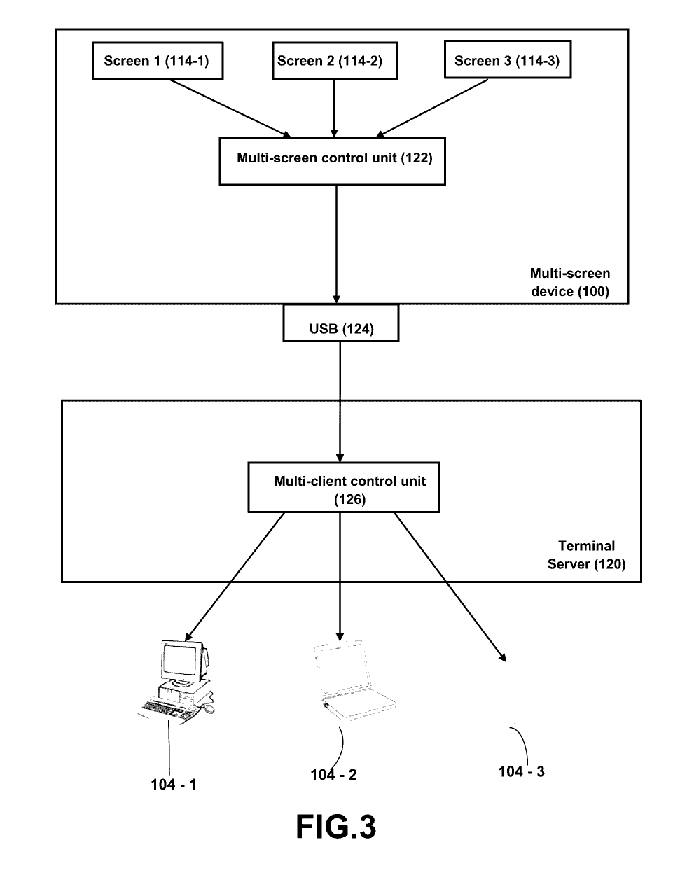

Referring to FIG. 3, transfer of responses of the user commands to the plurality of users is illustrated. The data i.e. the user commands may be executed on the corresponding screens and a response of execution of the user commands may be captured by corresponding multi-screen devices. In one case, the multi-screen control unit 122 may use a frame grab technique to capture the response of execution of the user commands. Using the frame grab technique, the multi-screen control unit 122 may identify a change in content displayed by the screens. The multi-screen control unit 122 may record continuously upon fixed intervals of time. The multi-screen control unit 122 may then compare each response of a screen with a previous response of the same screen to identify the change in content displayed by the screen.

Subsequent to determining the change in content displayed by the screens, the multi-screen device 100 may multiplex the response of the user commands to generate a multiplexed response data stream. The multi-screen control unit 122 may transmit the multiplexed response data stream to the USB port 124. The multiplexed response data stream may then be transmitted to the multi-client control unit 126 of the terminal server 120. The multi-client control unit 126 may demultiplex the multiplexed response data stream and may extract the response of the user commands. The multi-client control unit 126 may then provide the user devices with corresponding response of a corresponding user's commands.

Upon receiving the response of the user's commands, a respective user may check if received responses matches with expected responses. For an example, the user is aware of a response of a right-click command on a screen. Post receiving the response, the user may determine if the received response matches with the expected response. Based on the responses of the user commands received by the user devices, the users may determine a proper functioning of the multi-screen device 100, thereby testing screens of the multi-screen device 100. Thus, multiple screens of a plurality of multi-screen devices may be tested in an above described manner.

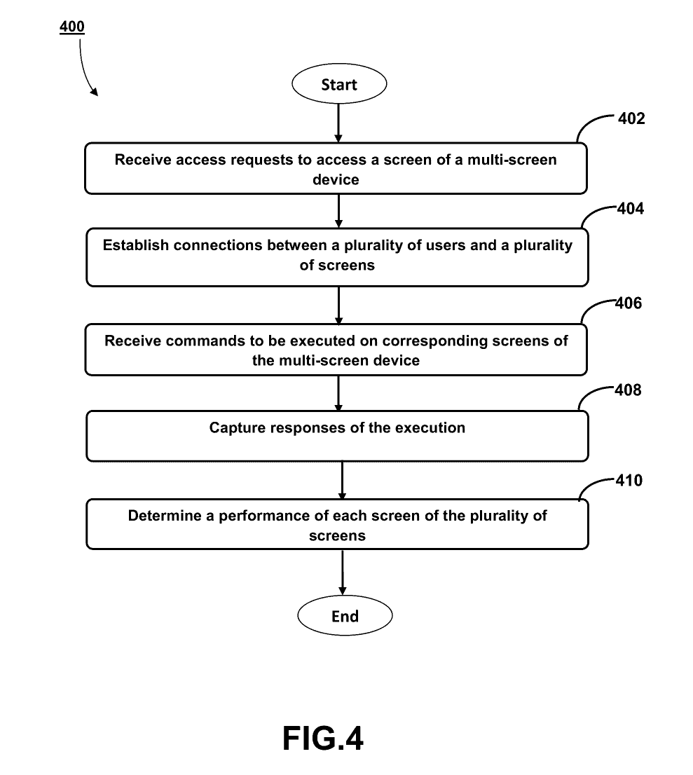

Referring now to FIG. 4, a method 400 for testing screens of a multi-screen device 100 is described, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above described multi-screen device 100.

At block 402, access requests may be received from a plurality of users to access a screen of a plurality of screens. The plurality of screens may belong to a multi-screen device 100. In one implementation, the access requests may be received by the processor 110.

At block 404, connections may be established between the plurality of users and the plurality of screens based on the connection requests. Each user may get connected to a single screen of the plurality of screens. In one implementation, the connections may be established by the processor 110.

At block 406, commands may be received from the plurality of users. The commands may be executed on corresponding screens of the multi-screen device 100. In one implementation, the commands may be received by the processor 110.

At block 408, responses of the execution may be captured. Further, responses of the execution may be captured using a frame grab technique. In one implementation, the responses of execution may be captured by the processor 110.

At block 410, a performance of each screen of the plurality of screens may be determined based on the responses. The performance may be determined to test the screens. In one implementation, the performance may be determined by the processor 110.

Although implementations for methods fortesting screens of a multi-screen device have been described in language specific to structural features and/or methods, it is to be understood that the appended claims are not necessarily limited to the specific features or methods described. Rather, the specific features and methods are disclosed as examples of implementations for testing screens of a multi-screen device.

Exemplary embodiments discussed above may provide certain advantages. Though not required to practice aspects of the disclosure, these advantages may include those provided by the following features.

Some embodiments may enable a multi-screen device and a method to test a plurality of screens of the multi-screen device.

Some embodiments may enable a multi-screen device and a method to test the plurality of screens present at different geographical locations.

Some embodiments may enable a method to simultaneously test a plurality of screens of a plurality of multi-screen devices.

We claim:

1. A method for testing screens of a multi-screen device, the method comprising:
receiving, by a processor, access requests from a plurality of users to access a screen of a plurality of screens of the multi-screen device;
establishing, by the processor, connections between the plurality of users and the plurality of screens based on the access requests such that each user is connected to a single screen of the plurality of screens;
receiving, by the processor, commands from the plurality of users, wherein the commands are executed on corresponding screens;
capturing, by the processor, responses of the execution using a frame grab technique; and
determining, by the processor, a performance of each screen of the plurality of screens based on the responses, thereby testing the plurality of screens.

2. The method of claim 1, wherein the access requests correspond to different screens available for testing.

3. The method of claim 1, further comprising indicating an availability status of each screen of the plurality of screens, for testing.

4. The method of claim 1, further comprising authenticating the connections established between the plurality of users and the plurality of screens.

5. A multi-screen device comprising:
a processor;
a memory coupled to the processor, wherein the processor executes program instructions stored in the memory, to:
receive access requests from a plurality of users to access a screen of a plurality of screens of the multi-screen device;
establish connections between the plurality of users and the plurality of screens based on the access requests such that each user is connected to a single screen of the plurality of screens;
receive commands from the plurality of users, wherein the commands are executed on corresponding screens;
capture responses of the execution using a frame grab technique; and
determine a performance of each screen of the plurality of screens based on the responses, thereby testing the plurality of screens.

6. The multi-screen device of claim 5, wherein the access requests correspond to different screens available for testing.

7. The multi-screen device of claim 5, further executes program instructions stored in the memory, to indicate an availability status of each screen of the plurality of screens, for testing.

8. The multi-screen device of claim 5, further executes program instructions stored in the memory, to authenticate the connections established between the plurality of users and the plurality of screens.

9. A non-transitory computer readable medium embodying a program executable in a computing device for testing screens of a multi-screen device, the program comprising:
a program code for receiving access requests from a plurality of users to access a screen of a plurality of screens of the multi-screen device;
a program code for establishing connections between the plurality of users and the plurality of screens based on the access requests such that each user is connected to a single screen of the plurality of screens;
a program code for receiving commands from the plurality of users, wherein the commands are executed on corresponding screens;
a program code for capturing responses of the execution using a frame grab technique; and
a program code for determining a performance of each screen of the plurality of screens based on the responses, thereby testing the plurality of screens.
